(19) United States
(12) Patent Application Publication
(10) Pub. No.: US 2007/0009335 A1
(43) Pub. Date: Jan. 11, 2007

(54) Drilling template

(76) Inventor: Ophelia R. Brewington, Wynne, AR (US)

Correspondence Address: Ophelia Ruth Brewington, 213 Lawson Ave., Wynne, AR, 72396, US

(21) Appl. No.: 11/178,253

(22) Filed: Jul. 9, 2005

(51) Int. Cl. B23B 47/28

(52) U.S. Cl. 408/115 R

(57) ABSTRACT

An apparatus is used to drill holes in the top area of the door on the hinge side of the door to install a door closer. The apparatus includes a template body that is installed over the top of the door with drill bushing to drill in door to install a door closer and a swivel compression clamp to hold the template in position while drilling the door.

### BACKGROUND OF THE INVENTION

At present drilling the holes in top area of door on hinge side of the door to attach a door closer is accomplished by taping a paper template to both sides of the door that is supplied by the closer manufacturer a center punch an hammer to mark the hole layout that are located on paper template.

My invention is used to drill holes in top area of door on hinge side of the door to attach a door closer by using the drilling template that is installed over the top of the door on hinge side of door with bushing in template body to match hole layout in closer to drill door on both sides of door.

### BRIEF DESCRIPTION OF DRAWING

FIG. 1 shows front view of template with drill bushings 2.

FIG. 2 shows right end view of the template with two parallel plates 3 attached together, eight drill bushings 2 in each side of the parallel plates opposite each other and a swivel compression clamp 4.

### DETAILED DESCRIPTION OF THE INVENTION

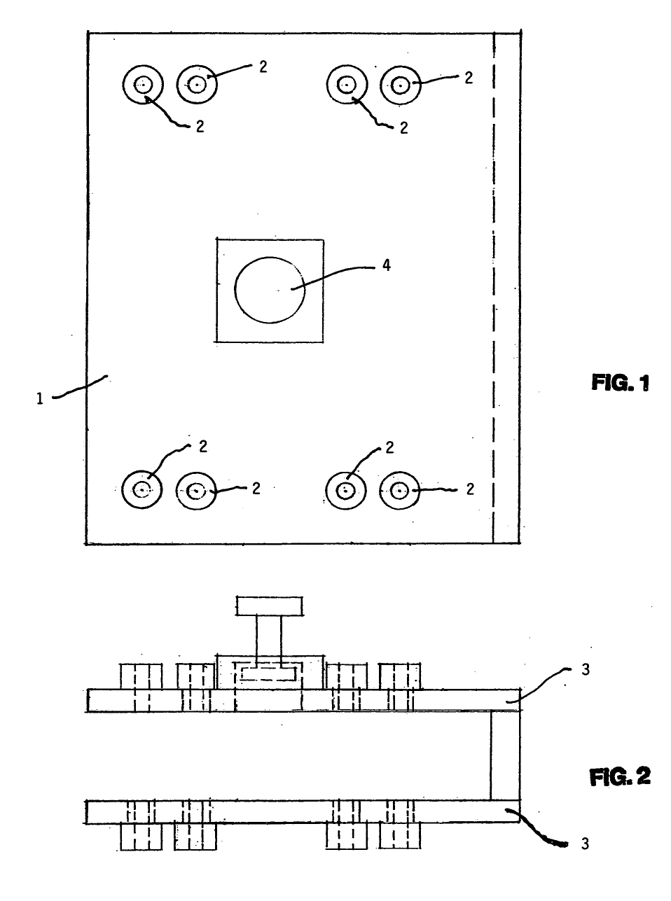

This invention is a drilling template used to drill the holes in top area of the door on the hinge side of the door to install a door closer. The drilling template body is generally designated 1 as shown in FIG. 1 and has two parallel plates 3 attached together as shown in FIG. 2 and generally consists of eight drill brushings in each parallel plate located opposite each other used to drill both sides of the door for a regular mount closer or parallel mount closer requiring sex bolts and a swivel compression clamp 4 as shown in FIG. 2.

1. What I claim as my invention is . . . “A drill template used for drilling the top area of the door on the hinge side of the door for the application of door closer.”

2. Referring to the drawing in further detail, the invention designated as shown in FIG. 1 and generally consists of two parallel plates 3 attached together as shown in FIG. 2 with drill bushings 2 and a swivel compression clamp 4.
